(19) United States
(12) Patent Application Publication
(10) Pub. No.: US 2008/0109251 A1
(43) Pub. Date: May 8, 2008

(54) Method of providing integrated healthcare services

(76) Inventor: Conrad V. Schmitt, Eden Prairie, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 11/594,340

(22) Filed: Nov. 8, 2006

(51) Int. Cl. G06Q 50/00; G06Q 90/00

(52) U.S. Cl. 705/2

(57) ABSTRACT

An integrative healthcare model is provided in which standard acute care medicine is supplemented by a process involving an awareness phase, an intervention phase, an education phase and a treatment phase which is implemented to address root causes of health issues and bring about lifestyle changes leading to improved health.

### BACKGROUND OF THE INVENTION

### I. Field of the Invention

The present invention relates to an improved healthcare delivery model. More specifically, the present invention relates to providing a healthcare delivery model that focuses on and provides incentives for improving overall health rather than focusing exclusively on the costs associated with the diagnosis and treatment of acute and chronic medical conditions through the use of medical procedures and drugs.

### BACKGROUND OF THE INVENTION

The healthcare system of the United States is currently driven by third party payers rather than patients and medical practitioners. Examples of such third party payers include insurance companies and government programs such as Medicare and Medicaid. Third party payers are primarily concerned with the money and mechanics of paying for medical care. The overall health of a patient is a secondary consideration. This system also creates an environment where healthcare providers and patients must concern themselves with what tests and what courses of treatment will be covered by the third party payer. All too often the healthcare system fails to employ evaluation methods, patient education methods and treatment options that will result in the improved long term health. The present system focuses on how to cure acute disease rather than how to prevent such disease.

The current third party payment system also has inherent administrative burdens. Claims must be filed and processed to ensure payment for the tests and treatment provided using up resources that could otherwise be used to provide better healthcare.

Insurance policies are also written in a very complex way. A variety of deductibles, co-pay, co-insurance, exemptions and exclusions are used by the third party payer to control its financial exposure rather than promote health. This only adds to the administrative burden causing money rather than patient care to be the focus.

In many places, there is also no real competition between third party payers nor any incentive to control costs. None compete based on results. All use essentially the same premium structure. All look at the utilization experience and other actuarial information to determine the number and amount of claims that can be expected for a group of individuals. Third party payers then add in a fee to cover the administrative services of the third party payer. The third party payer simply passes all of this along in the form of premium charges and has no incentive to improve health. In fact, the higher the claims experience, the more that can be charged by third party payer for its administrative services.

While patients can usually, but not always, choose doctors and hospitals, they have no choice regarding treatment options. These are controlled in a very real way by the third party payers.

In view of the problems with the current healthcare system, there is a real need to create a system where the health of the patient becomes of paramount concern. To achieve this, the incentives that control the healthcare system must change. This is only achieved by making all involved in healthcare accountable for improving the health rather than delivering treatment.

It has been estimated that 80% of illnesses are caused by lifestyle. Lifestyle diseases are not treatable by modern medicine. They are self-generated and are self-cured. It has also been estimated that 94% of the individuals generating insurance claims had lifestyle issues such as smoking, drinking, nutritional problems, and problems with stress. The current third party payer system is designed to address acute conditions that arise from these lifestyle issues, but not the underlying cause of the problem. Thus, there is a real need to create a system where the underlying lifestyle causes are addressed. Most chronic diseases can be reversed by lifestyle changes.

### SUMMARY OF THE INVENTION

The present invention discards the old system of paying for healthcare with traditional insurance. Instead, the present invention provides a results-based direct payment system for total healthcare that includes addressing the mental, physical and spiritual issues that can lead to illness. Under this direct payment system, there are no insurance claims for primary care. Instead, multidisciplinary clinics will be paid negotiated fixed fees to provide total healthcare to a defined population. These multidisciplinary clients will be responsible not only for standard medical care, but also holistic, alternative, adjunctive, complementary medical care including without limitation mental healthcare and treatment of addictions at no extra cost.

The multidisciplinary clinics will be staffed by board certified physicians, chiropractors, psychologists, nurses, nutritionists, certified health coaches, certified fitness trainers, and food, alcohol and drug addiction specialists. The multidisciplinary clinics will employ a multi-step process with the patients for generating lifestyle changes that will lead to improved health. This multi-step process, explained in greater detail below, involves an awareness phase, an intervention phase, an educational phase, and a treatment phase. Briefly, this process is designed to (1) identify underlying causes of health problems; (2) create awareness on the part of the patient of the problems, the associated risks and alternatives available; and (3) create and implement a health plan that is individualized for the patient, that the patient understands, and to which the patient is committed.

### BRIEF DESCRIPTION OF THE DRAWINGS

FIG. 1 is a diagram depicting a standard insurance based acute care delivery model commonly used in the prior art.

FIG. 2 is a diagram depicting the integrative medical care solution provided by the present invention.

FIG. 3 is a chart depicting the composition of a clinic designed to implement the present invention.

FIG. 4 is a chart depicting services provided by the clinic staffed as depicted in FIG. 3.

FIG. 5 is a flow chart showing the method of the present invention.

### DETAILED DESCRIPTION

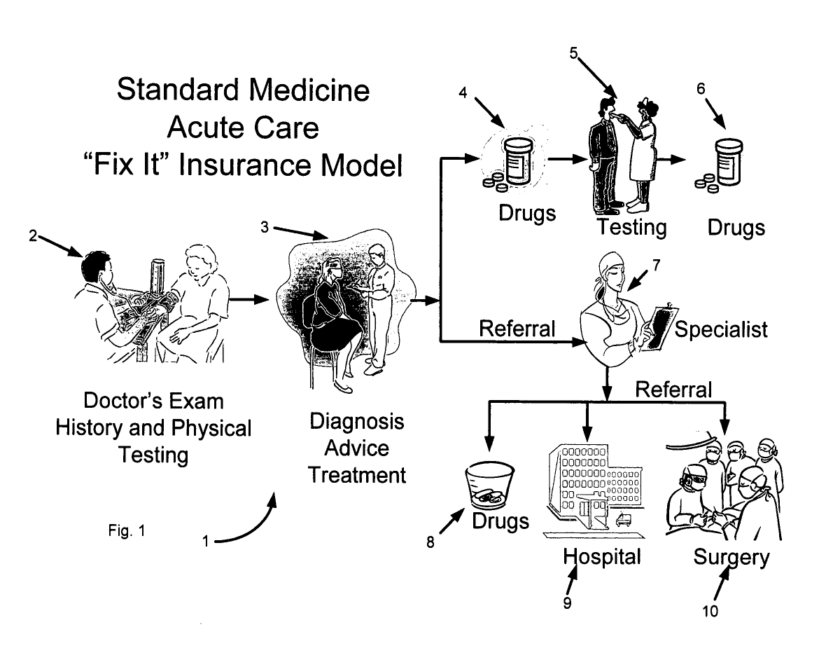

In today's acute care, the third party payer model 1 will first be described with reference to FIG. 1. As shown, the course of medical treatment begins with a doctor's exam 2. During the examination 1 the doctor takes a medical history focusing on the symptoms that caused the patient to visit the doctor. During the examination 2, the doctor and the doctor's staff take certain measurements (e.g., weight, height, temperature, blood pressure, etc.) and perform certain tests (e.g., blood tests, X-rays, etc.). Based upon the medical history measurements and testing, the doctor makes a diagnosis and discusses treatment or next steps with the patient 3. Typically, treatment is drug-based. The doctor prescribes drugs designed to address the acute condition that lead to the visit and the patient takes the drugs 4. There may be follow-up testing 5 and more drugs 6. If such therapy does not cure the acute condition, the next step is for the physician to refer the patient to a specialist 7. The specialist then uses drugs 8, hospital-based therapy 9, or surgery 10 to address the acute condition.

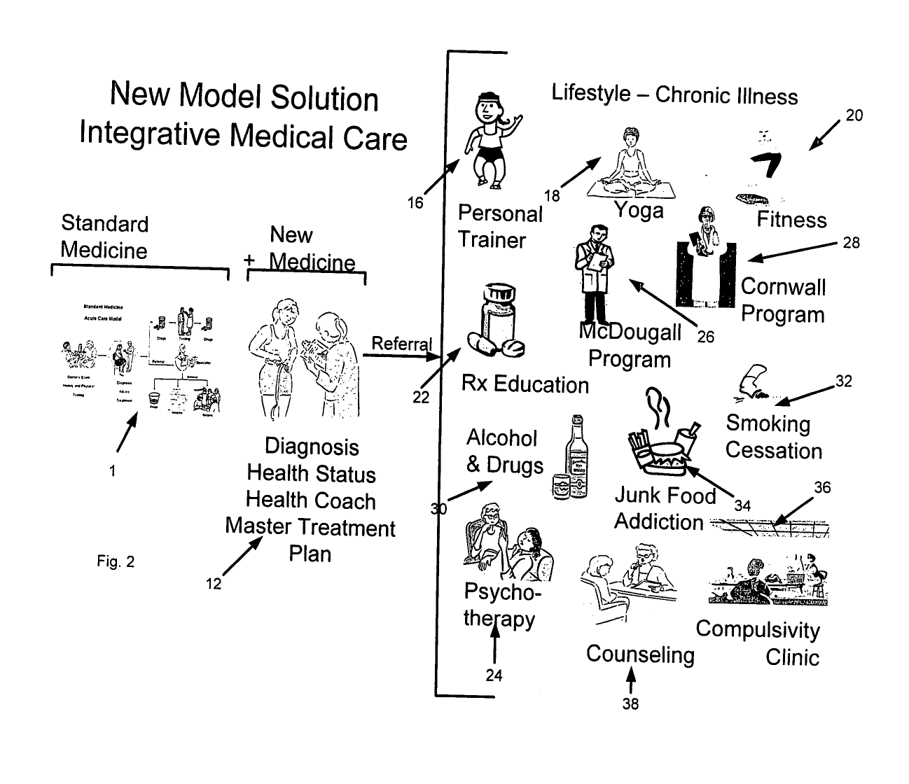

In the current delivery model, little consideration is given to the lifestyle issues that caused the acute condition and may cause the same acute condition or other acute conditions to arise in the future. The present invention addresses this by adding to the standard medicine described above a whole new protocol designed to focus on the root causes of health problems and implement lifestyle changes that will bring about improved health. This is done with the intent of not only benefiting the patient, but also reducing the total cost of medical care for a population of patients. This new protocol is represented by FIG. 2.

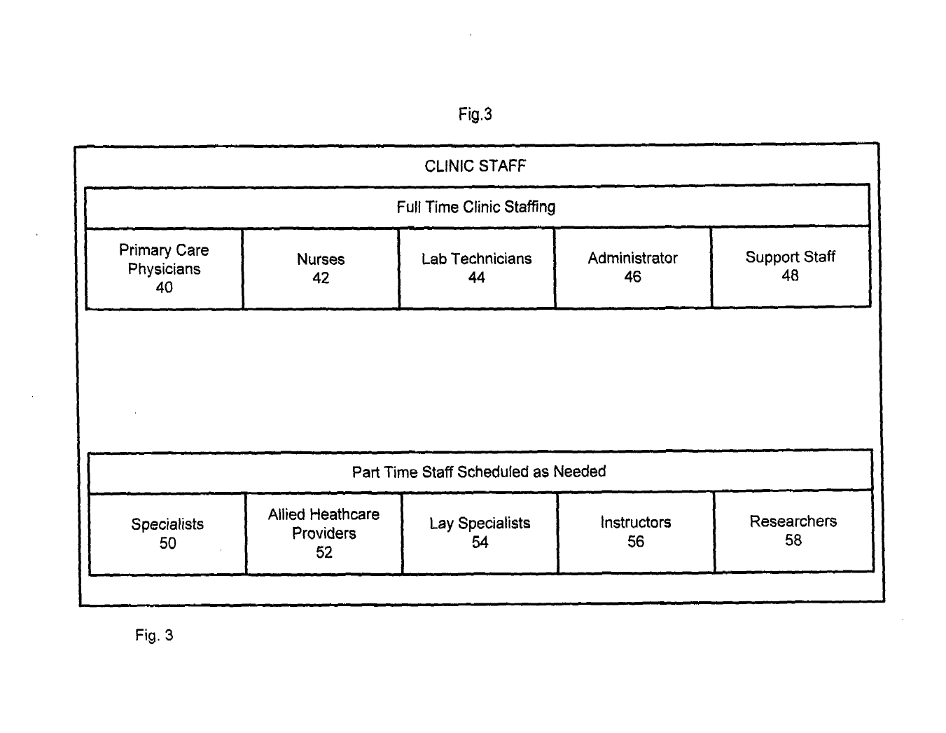

As shown in FIG. 2, this new treatment protocol has all the treatment options available in the prior art acute care third party payer model 1. However, the present invention adds a “new medicine” component 12. This “new medicine” component is performed by a team comprising the patient and one or more health professionals. Typically, the team will comprise a plurality of health professionals selected from groups 40-58, are represented in FIG. 3 and described in greater detail below. An integral role will be played by psychological service providers such as psychologists, psychotherapists, psychiatrists, addiction specialists and health coaches.

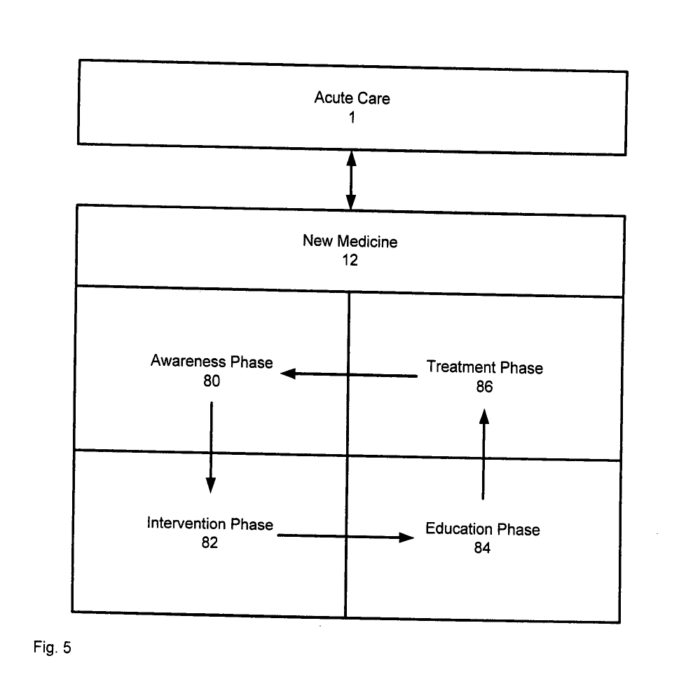

As shown in FIG. 5, the “new medicine” component 12 includes four phases. The first phase, referred to as the “awareness phase”, is designed to create an awareness on the part of team members of the root causes of health issues faced by the patient. While data derived from standard diagnostic procedures is collected during this phase, the team also looks at physical, heredity, environmental, psychological, emotional and spiritual condition of the patient. The purpose of this phase is to identify the full set of issues the patient has rather than focusing only on those which are most acute.

The second phase, referred to as the “intervention phase” 82, is performed by a medical doctor, a health coach and the patient. Other members of the team may also be invited to participate. During the intervention phase, the participants build on the information collected to better define for the patient the issues the patient is encountering and develop on the part of the patient an appreciation of the need to address such issues if the patient's overall health is to improve. in this way, issues facing the overall health of the patient are articulated.

The intervention phase is followed by an educational phase 84. During this phase, trained professionals help the patient gain a greater understanding of the alternative approaches available that can lead to improved health. The patient learns about the drugs available to treat disease conditions the patient is encountering or likely to encounter. Such learning relates to the intended use of the drugs, side effects of the drugs, risks associated with the drugs and how the drugs used to treat different conditions can interact with each other in either a positive or negative fashion. The patient also learns about risk factors and how lifestyle changes can temper these risk factors. Often, these risk factors are associated with nutrition, weight, stress or the like. The patient also learns about a full gamut of alternative disciplines that can be used to bring about lifestyle changes. These alternative disciplines range from psychological and spiritual counseling, to fitness and yoga training, to nutrition, health food and diabetics training, to the use of allied medicines such as acupuncture, chiropractors and the like. The entire program is based upon the premise that once the patient has gained an understanding of the health issues the patient must confront and the assistance available, the patient will take more ownership in developing and implementing a treatment plan. The resources referenced in FIG. 3 are used as appropriate during the educational phase.

The final phase is the treatment phase 86. This phase begins with the patient working with other members of the team to develop an individualized treatment plan. The resources necessary to carry out the plan are then utilized to carry out the plan. The plan typically will involve a group process, sometimes a health retreat to jump start the process of achieving lifestyle change, and regular follow up. Of course, improved health results from continual assessment and adjustment. FIG. 5 shows the four phases repeating themselves.

FIG. 2 shows a number of resources that can be accessed by the team in planning and implementing treatment. Use of these programs is, of course, based upon patient needs. If stress is a root cause of patient problems, the services of a personal life trainer 16, yoga instructor 18 or psychotherapist 24 can be employed. If fitness issues are a root cause of problems, the services of a yoga instructor 18 or a fitness trainer 20 can be utilized. Many patients are already taking a number of different drugs to treat chronic or acute conditions. In such cases, the services of a pharmacist 22 can be employed to evaluate whether the right combination of drugs is being used by the patient. Certain patients have health issues arising from addiction. Different programs can be utilized based upon the type of addiction, e.g., drug and alcohol 30, tobacco 32, food 34 or other compulsive issues 36. Inpatient, outpatient or community based (e.g., Alcoholics Anonymous, Overeaters Anonymous) addiction programs can be employed. Similarly, McDougall 26 or Cornwall 28 programs can be utilized. McDougall and Cornwall programs emphasize the benefits of an improved diet and exercise as a vehicle for improved health. If issues are less severe, other counseling techniques 38 can be employed. Also, the patient may elect a permanent change in environment if necessary to bring about desired change. Which of the foregoing will be utilized and how they will be utilized, will depend on the treatment plan developed by the patient and the other members of the team.

In developing the treatment plan as part of the treatment phase, the goal will be to help patients reverse their disease process and achieve a higher level of health and wellbeing. This will be achieved through an extensive education, the patient's decision to make lifestyle changes, and supporting the patient in his or her efforts to make such changes. The result should be a reduction in the need to utilize acute care medical resources and prescription drugs.

To provide the services outlined above, medical clinics will have to look differently than they do today. FIG. 3 is a chart showing the preferred organization of a clinic. Clinics, however, can be organized differently than shown and still be able to implement the present invention. Most clinics today employ physicians 40, nurses 42, lab technicians 44 and other support staff 48. Most also have an office manager or administrator 46 that deals with the business aspects of the medical practice. However, when the present invention is implemented, the organization of the clinic changes in several ways.

First, while the clinic still employs primary care physicians 40, the clinic is also staffed from time to time by specialists 50 who are scheduled in on an as-needed basis to consult with the primary care physicians and their patients. This replaces many of the referrals that now occur and allows the primary care physician, the specialist and the patient to meet together.

Second, the clinic also is staffed from time to time by allied healthcare providers 52. Examples include pharmacists, physical therapists, chiropractors and psychologists. The clinic is also staffed from time to time by lay specialists 54. Examples include health coaches, various instructors, addiction specialists and nutritionists. Various instructors 52 are also scheduled as needed. Examples include fitness trainers, yoga instructors, and cooking instructors. Again, these professionals are scheduled in on an as-needed basis so they can serve as part of the team assembled to work with individual patients.

Third, the clinic has a research department 58 that supports the multidisciplinary individualized teams organized for each patient. As part of the research department, the clinic may also have a director of development who works not only to gain financial support for the clinic, but also works to recruit the personnel necessary to create the individualized multidisciplinary teams and investigates the nature of resources available elsewhere.

Fourth, there is a clinic administrator 46 that is responsible for far more than managing the business aspects of the practice. This person is actively involved in matching the patient and the primary care physician with the other resources identified in FIGS. 2 and 3 to form the teams. It is this team that will provide services during all four phases—awareness, intervention, education and treatment—of the program.

Of course, the clinic described above will not function without the support of the medical community and the patients and employers of patients who now pay for medical care. The clinic administrator, director of development and the rest of the research department will play a key role in marketing and business development.

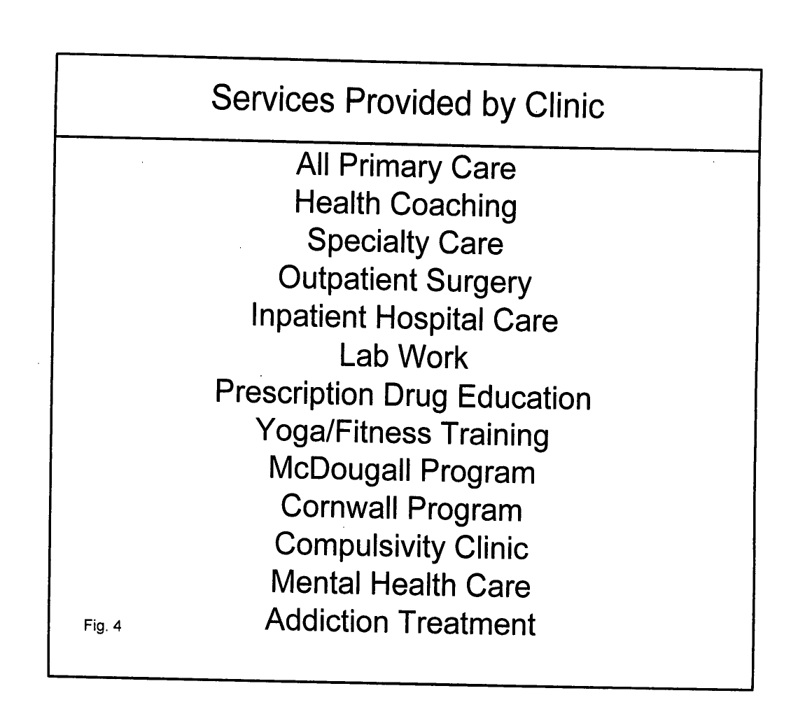

In the new model described above, the staff of the clinic will provide a full range of services. These are listed in FIG. 4. Most will be provided for a single fixed fee. These services include all primary care, health coaching, patient oversight during hospital stays, prescription drug education, yoga and fitness training, and mental health care. The clinic will also provide services related to compulsive disorders, addictive disorders, aging issues, and the above-referenced McDougall and Cornwall programming at no additional charge. Hospital stays will be covered separately under a traditional insurance model. There may also be co-insurance related to specialist care and testing as an incentive to ensure that these expensive items are not unreasonably utilized. Likewise, certain tests and other types of case may be excluded if they are not effective or do not correspond to the treatment plan developed for the patient.

A principal benefit of the present invention is that it results in greater accountability for improved health. Employers and other insurance groups know what they are currently paying in premiums under the traditional insurance health care model. They will only pay for the “new model” if it results in overall savings. Such savings will only occur if the overall health of the group members improves.

Additionally, each clinic offering the “new model” of the present invention will compete on price, quality and outcomes. Those clinics that are most effective in improving overall health of group members will be most attractive to the consumer.

Initially, some members of a group may be reluctant to change doctors that they have used for an extended period of time. This reluctance ultimately is based upon a lack of knowledge and an inability to differentiate between the outcomes of various treatment modalities. This reluctance will be overcome by providing a high level of education and permitting the patient to participate more fully in developing a treatment plan.

Of course, variations of the foregoing can occur without deviating from the present invention. As such, the discussion above is intended to be illustrative rather than limiting. The scope of the invention covered is limited only by the following claims.

What is claimed is:

1. A method of organizing a medical clinic and providing services for a patient comprising:
a. employing a plurality of primary care physicians, nurses and lab technicians and psychological service providers selected from a group consisting of psychologists, psychiatrists, psychotherapists, addiction specialists, and health coaches;
b. employing on an as-needed basis the services of other staff selected from the group consisting of specialists, allied healthcare providers, lay specialists, instructors and researchers;
c. creating individualized multi-disciplinary teams comprising the patient, at least one primary care physician, and at least one other provider selected from those identified in step a or step b; wherein members of the team participate in (i) an awareness phase during which a thorough diagnostic workup related to the health of the patient, including without limitation an evaluation of the patient's physical, spiritual, psychological and emotional condition of the patient, is performed; (ii) an interventional phase wherein issues faced by the patient that affect overall health are articulate; (iii) an educational phase during which the patient learns about alternative approaches available that can lead to improved health; and (iv) a treatment phase wherein an individualized plan for the patient is created by the team and then implemented using resources offered through the clinic and elsewhere.

2. A method of organizing a medical clinic and providing services for a patient comprising:
a. employing a plurality of primary care physicians, nurses and lab technicians and psychological service providers selected from a group consisting of psychologists, psychiatrists, psychotherapists, addiction specialists, and health coaches;
b. employing on an as-needed basis the services of other staff selected from the group consisting of specialists, allied healthcare providers, lay specialists, instructors and researchers;
c. creating individualized multi-disciplinary teams comprising the patient, at least one primary care physician, and at least one other provider selected from those identified in step a or step b; wherein members of the team participate in (i) an awareness phase during which a thorough diagnostic workup related to the health of the patient, including without limitation an evaluation of the patient's physical, spiritual, psychological and emotional condition of the patient, is performed; (ii) an interventional phase wherein issues faced by the patient that affect overall health are articulate; (iii) an educational phase during which the patient learns about alternative approaches available that can lead to improved health; and (iv) a treatment phase wherein an individualized plan for the patient is created by the team and then implemented using resources offered through the clinic and elsewhere; and
d. negotiating and charging a fixed fee for the patient to receive the services offered to the patient by the clinic.

3. A method of organizing a medical clinic and providing services for a patient comprising:
a. employing a plurality of primary care physicians, nurses and lab technicians and psychological service providers selected from a group consisting of psychologists, psychiatrists, psychotherapists, addiction specialists, and health coaches;
b. employing on an as-needed basis the services of other staff selected from the group consisting of specialists, allied healthcare providers, lay specialists, instructors and researchers;
c. creating individualized multi-disciplinary teams comprising the patient, at least one primary care physician, and at least one other provider selected from those identified in step a or step b; wherein members of the team participate in (i) an awareness phase during which a thorough diagnostic workup related to the health of the patient, including without limitation an evaluation of the patient's physical, spiritual, psychological and emotional condition of the patient, is performed; (ii) an interventional phase wherein issues faced by the patient that affect overall health are articulate; (iii) an educational phase during which the patient learns about alternative approaches available that can lead to improved health; and (iv) a treatment phase wherein an individualized plan for the patient is created by the team and then implemented using resources offered through the clinic and elsewhere; and
d. negotiating and charging a fixed fee for the patients who are members of a group to receive the services offered to the members of the group by the clinic.

4. A method of organizing a medical clinic and providing services for a patient comprising:
a. employing a plurality of primary care physicians, nurses and lab technicians and psychological service providers selected from a group consisting of psychologists, psychiatrists, psychotherapists, addiction specialists, and health coaches;
b. employing on an as-needed basis the services of other staff selected from the group consisting of specialists, allied healthcare providers, lay specialists, instructors and researchers;
c. providing primary physician care for the patient; and
d. creating and implementing an individualized treatment plan for the patient using a multi-disciplinary team comprising the patient, at least one primary care physician, and at least one other provider selected from those identified in step a or step b; wherein said individualized treatment plan is created and implemented by said team completing (i) an awareness phase during which a thorough diagnostic workup related to the health of the patient, including without limitation an evaluation of the patient's physical, spiritual, psychological and emotional condition of the patient, is performed; (ii) an interventional phase wherein issues faced by the patient that affect overall health are articulate; (iii) an educational phase during which the patient learns about alternative approaches available that can lead to improved health; and (iv) a treatment phase wherein an individualized plan for the patient is created by the team and then implemented using resources offered through the clinic and elsewhere.

5. The method of claim 4 wherein the clinic negotiates and charges a fixed fee for the patient to receive the services offered to the patient by the clinic.

6. The method of claim 4 wherein the clinic negotiates and charges a fixed fee for patients who are members of a group to receive the services offered to the members of the group by the clinic.
